(19) United States
(12) Patent Application Publication
(10) Pub. No.: US 2005/0022322 A1
(43) Pub. Date: Feb. 3, 2005

(54) Powered toothbrush with curved neck and flexible shaft and single battery

(76) Inventors: Eduardo Jimenez, Manalapan, NJ (US); Dan Cuffaro, Melrose, MA (US); Christine Enderby, Chelsea, MA (US); Thomas Swyst, Arlington, MA (US)

Correspondence Address: COLGATE-PALMOLIVE COMPANY, 909 RIVER ROAD, PISCATAWAY, NJ, 08855, US

(21) Appl. No.: 10/436,395

(22) Filed: May 12, 2003

(51) Int. Cl. A61C 17/22

(52) U.S. Cl. 15/22.1; 15/28

(57) ABSTRACT

A powered toothbrush having a curved neck, a flexible shaft within the neck and a single battery is provided. In a preferred embodiment, a powered toothbrush having a curved neck of a constant radius, a flexible unitary shaft, a single battery power source and a clutch mechanism to disengage the flexible shaft from a drive mechanism upon overload is provided.

### BACKGROUND OF THE INVENTION

1. Field of the Invention

The present invention relates to powered toothbrushes, and more particularly, to a powered toothbrush having a curved neck of a constant curvature and a curved flexible shaft and using a single battery as the power source.

2. Discussion of Related Art

Toothbrushes provide many oral hygiene benefits. For example, toothbrushes remove plaque and food debris to help avoid tooth decay and disease. They remove stained pellicle from the surface of each tooth to help whiten the teeth. Also, the bristles combined with the brushing motion massage the gingival tissue for stimulation and increased health of the tissue.

Powered toothbrushes have been available for some time. Powered toothbrushes have advantages over manual (non-powered) toothbrushes in that they impart movement to the bristles at much higher speeds than possible manually. They also may impart different types and directions of motion. These motions, generally in combination with manual movement of the toothbrush by a user, provide superior cleaning than manual toothbrushes. Typically, powered toothbrushes are powered by disposable or rechargeable batteries that power an electric motor that in turn drives a toothbrush head.

Known powered toothbrushes include a brush head with a bristle carrier portion that rotates, oscillates or vibrates in some manner so as to clean the teeth. The bristles, which typically comprise bristle tufts, are generally uniform with one end fixed into the bristle carrier portion and the other end free to contact the surface of the teeth while brushing. The free ends of the various tufts present a surface envelope that is capable of some deformation when the bristles bend. When in contact with the surface to be brushed, the bristles may deform so that the surface envelope tends to conform to the complex surface of the teeth. Human teeth generally lie in a “C” shaped curve within the upper and lower jaw bones, and each row of teeth consequently has a convex outer curve and a concave inner curve. Individual teeth often have extremely complex surfaces, with areas that may be flat, concave or convex. The more precise the contact between the bristles and the tooth surface, the more effective the toothbrush may be in cleaning, whitening and/or stimulating.

Although powered toothbrushes such as those described immediately above provide advantages over manual toothbrushes, they are not designed for engaging teeth in hard to reach areas of the mouth. Further, the shafts of such powered toothbrushes are not designed to allow for efficient contact between the bristles and the tooth surface. Additionally, such powered toothbrushes utilize multiple, segmented drive shafts coupled to gears, which complicate the powered toothbrush and increase the failure rate. Further still, such powered toothbrushes utilize a plurality of batteries that add to the weight of the toothbrush and increase the cost of replacement batteries.

### OBJECTS OF THE INVENTION

Therefore, it is an object of the invention to provide a powered toothbrush which avoids the aforementioned deficiencies of the prior art.

It is also an object of this invention to provide a powered toothbrush with improved ergonomic design.

It is another object of this invention to provide a powered toothbrush with a curved neck of a constant curvature and a single flexible shaft.

It is a further object of this invention to provide a powered toothbrush wherein the single flexible shaft is not engaged to gears.

It is still another object of this invention to provide a powered toothbrush with a clutch mechanism.

It is yet another object of this invention to provide a powered toothbrush utilizing a single battery as its power source.

Various other objects, advantages and features of the present invention will become readily apparent from the ensuing detailed description and the novel features will be particularly pointed out in the appended claims.

### SUMMARY OF THE INVENTION

This invention relates to a powered toothbrush which has been designed to clean teeth in hard to reach areas of the mouth. The powered toothbrush of this invention includes a handle portion having a base member at one end thereof. A curved neck portion extends from the other end of the handle portion with a head coupled to the neck. The head includes at least one bristle carrier, preferably at least two bristle carriers, connected to a flexible drive shaft for moving at least one of the bristle carriers in a first rotatable direction.

In accordance with one embodiment of the present invention, a powered toothbrush is provided including a handle having an inner cavity formed therein and a base member at one end thereof; a rotary drive member disposed within the inner cavity; a curved tubular neck portion extending from the other end of the handle portion with a head coupled to the neck portion, the head including at least one bristle carrier comprising bristles, wherein the at least one bristle carrier is adapted to move in a first rotational direction; a flexible drive shaft for moving the at least one bristle carrier in a first rotational direction, having a first end and a second end, rotatably disposed within the curved tubular neck portion, the first end thereof being drivably connected to the drive member and the second end thereof extending through the outer end of the curved tubular neck portion, the flexible drive shaft being rotationally responsive to the rotary drive member; and a single battery to power the rotary drive member.

In accordance with another embodiment of the present invention, a powered toothbrush is provided including a handle having an inner cavity formed therein and a base member at one end thereof; a rotary drive member disposed within the inner cavity; a curved tubular neck portion having a constant radius extending from the other end of the handle portion with a head coupled to the neck portion, the head including at least one bristle carrier comprising bristles, wherein the at least one of the bristle carrier is adapted to move in a first rotational direction; a flexible drive shaft for moving the at least one bristle carrier in a first rotational direction, having a first end and a second end, rotatably disposed within the curved tubular neck portion, the first end thereof being drivably connected to the drive member and the second end thereof extending through the outer end of the curved tubular neck portion, the flexible drive shaft being rotationally responsive to the rotary drive member; and a single battery to power the rotary drive member.

In accordance with yet another embodiment of the present invention, a powered toothbrush is provided including a handle having an inner cavity formed therein and a base member at one end thereof; a rotary drive member disposed within the inner cavity, the drive member including a clutch mechanism; a curved tubular neck portion extending from the other end of the handle portion with a head coupled to the neck portion, the head including at least one bristle carrier having bristles, wherein the at least one bristle carrier is adapted to move in a first rotational direction; and a flexible drive shaft for moving the at least two bristle carriers in a first rotational direction, having a first end and a second end, rotatably disposed within the curved tubular neck portion, the first end thereof being drivably connected to the drive member and the second end thereof extending through the outer end of the curved tubular neck portion, the flexible drive shaft being rotationally responsive to the rotary drive member; a single battery to power the rotary drive member; and wherein the clutch mechanism disengages the flexible drive shaft upon an overpressure to prevent damage to the bristles.

In accordance with still another embodiment of the present invention, a powered toothbrush is provided with a single battery which drives a unitary flexible direct drive shaft with a curved section through a curved neck section to, in turn, drive at least two bristle carriers with bristles which extend generally to intersect the longitudinal axis of a handle section of the toothbrush.

### BRIEF DESCRIPTION OF THE DRAWINGS

The following detailed description given by way of example, but not intended to limit the invention solely to the specific embodiments described, may best be understood in connection with the accompanying drawings in which:

FIG. 1 is a side elevational view of a preferred embodiment of a powered toothbrush in accordance with the teachings of the present invention.

### DETAILED DESCRIPTION OF CERTAIN PREFERRED EMBODIMENTS OF THE PRESENT INVENTION

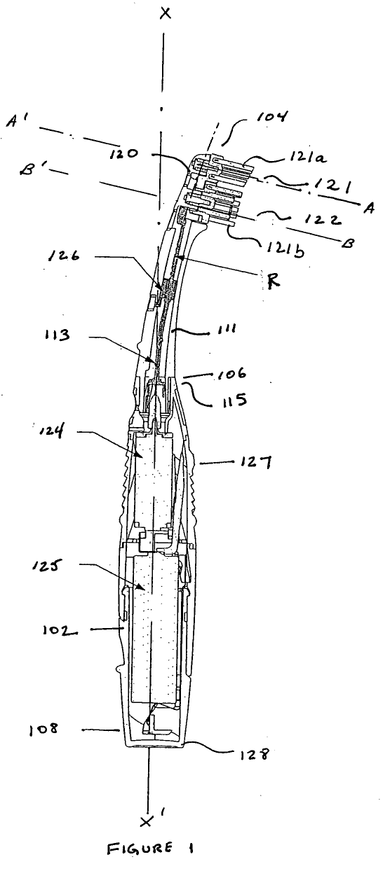

Referring now to the drawings, wherein like reference numerals represent like features in the several views, a preferred embodiment of a powered toothbrush in accordance with the teachings of the present invention is shown in FIG. 1. As is shown in FIG. 1, the powered toothbrush 100 includes a handle portion 102 at a proximal end thereof that defines an interior compartment for housing various toothbrush components, and a brush section 104 that is defined by a neck portion 110 that terminates in a head 120 at a distal end of toothbrush 100. The handle portion 102 has a free proximal base support end member 108. The neck portion 110 is the portion of the powered toothbrush 100 that extends between handle 102 and head 120. The neck portion 110 also defines an interior compartment 111 for housing various components of the toothbrush, such as curved flexible shaft 113. Preferably, powered toothbrush 100 is water-repellant.

The neck portion 110 and the handle portion 102 can be constructed as a unitary member by forming neck portion 110 integral to handle portion 102 at neck end 106 of the handle portion 102, or can be formed detachable from handle portion 102 at neck end 106 of neck portion 110. In accordance with this detachable embodiment, combined neck portion 110 and head 104 can be removed from the handle portion 102 to permit cleaning, servicing and/or interchanging of either handle 102 or the combined neck 110 and head 120 (brush section 104). When the neck portion 120 is formed to be detachable from handle 102, neck end 106 preferably includes a connector linkage 115 that is adapted to be detachably joined to handle portion 102 using traditional techniques. It will be appreciated that the point of attachment may be between the head portion 120 and the neck portion 110 such that the head 120 is of a refill type head. Furthermore, the head 120 is formed of a first bristle carrier 121 which rotates in a first rotational direction. First bristle carrier 121 includes a plurality of bristles 121a. The head 120 also includes a second bristle carrier 122 which can either include stationary bristles, or rotate in the same direction as first bristle carrier 121, or in an opposite direction therefrom. Second bristle carrier 122 includes a plurality of bristles 122a.

In a preferred embodiment, bristles 121a and 122a are generally arranged parallel to axes A-A′ and B-B′, respectively, wherein axes A-A′ and B-B′ intersect longitudinal axis X-X′ of handle 102. In another embodiment, bristles 121a and 122a are criss-crossed.

Polymeric materials, such as plastics, or other suitable materials may be used to fabricate the neck, handle and flexible drive shaft. Preferably, thermoplastic elastomers may be used to fabricate the flexible drive shaft.

In a preferred embodiment, the curved neck is of a constant curvature with a radius R, as seen in FIG. 1. R is from about 150 mm to about 450 mm. Preferably, R is 250 mm.

The powered toothbrush 100 includes a drive mechanism to effectuate certain movement of certain parts of the toothbrush, and more specifically for causing movement of the movable bristle carrier 121, and bristle carrier 122, if movable via unitary flexible drive shaft 113. One exemplary drive mechanism is disclosed in U.S. Pat. No. 5,625,916 to McDougall, which is incorporated herein by reference.

The drive mechanism for powered toothbrush 100 can be any type of drive, e.g., a rotating drive, an oscillating drive, an eccentric drive, an unbalanced-generated drive, a drive having one or more gearing mechanisms, and/or the like, that is capable of performing the intended function. The drive mechanism can be realized in the form of an electric motor or other type of motor and the movement generated by the drive can be imparted to one or more sections of the head or to other elements which can be present at the brush section, such as bristle tufts and elastomeric members. When the toothbrush 100 includes an oscillating drive mechanism, for example, the interior compartment of a handle 102 houses the motor 124 operatively connected to the drive shaft and a source to power the motor.

The power source is a single battery 125. Battery 125 is typically positioned in an upright configuration within the interior compartment of handle 102, preferably below motor 124. However, alternate ways of positioning the battery are possible.

Battery 125 may be removable or fixed, rechargeable, non-rechargeable or rechargeable from an external source. Further, battery 125 may be of any size, such as, for example, AA, AAA, 9V and C.

To replace or recharge battery 125, cover 128 is released from the end of handle 102 to open and expose the hollow portion of the handle. The battery is then removed, a new one inserted (or the old one recharged), and the cover is then moved into position and snapped into place. In one embodiment, battery 125 may be fixed within handle 102 and recharged from an external source.

If desired for overload protection, a conventionally designed, spring-loaded, slipping clutch may be included at any convenient location. A clutch is any of the various number of devices for engaging and disengaging two working parts of a shaft or of a shaft and a driving mechanism. As it relates to powered toothbrush, the integration of a clutching mechanism, for example, avoids stalling of the motor when excessive force is applied to the brush carrier(s).

In a preferred embodiment, clutch 126 connects flexible drive shaft 113 to motor 124. Clutch 126 is adapted to disengage flexible drive shaft 113 from motor 124 upon overpressure, thereby preventing or minimizing damage to, for example, bristle carriers 121 and 122.

When the drive mechanism is actuated and the flexible drive shaft is rotated, the movement of a crank end thereof imparts an oscillating back and forth movement of bristle carrier 121, and optionally, bristle carrier 122, through an angle between about 10° to about 60°. In a preferred exemplary embodiment, the movement is through an angle of between 10° to about 30°.

In order to simplify user interface, the powered toothbrush of this invention includes on/off switch 127 for activating/deactivating the motor. Preferably, on/off switch 127 is provided along a face of the handle portion in a thumb depression.

Although the invention has been particularly shown and described with reference to certain preferred embodiments, it will be readily appreciated by those of ordinary skill in the art that various changes and modifications may be made therein without departing from the spirit and scope of the invention. It is intended that the claims be interpreted as including the foregoing as well as any such changes and modifications.

1. A powered toothbrush comprising:
a handle having an inner cavity formed therein and a base member at one end thereof;
a rotary drive member disposed within the inner cavity;
a curved tubular neck portion extending from the other end of the handle portion with a head coupled to the neck portion, the head including at least one bristle carrier comprising bristles, wherein at least one of the bristle carriers is adapted to move in a first rotational direction;
a flexible drive shaft for moving the at least one bristle carrier in a first rotational direction, having a first end and a second end, rotatably disposed within the curved tubular neck portion, the first end thereof being drivably connected to the drive member and the second end thereof extending through the outer end of the curved tubular neck portion, the flexible drive shaft being rotationally responsive to the rotary drive member; and
a single battery to power the rotary drive member.

2. The powered toothbrush according to claim 1, wherein said powered toothbrush comprises at least two bristle carriers.

3. The powered toothbrush according to claim 1, wherein the single battery is removable or fixed, rechargeable, non-rechargeable or rechargeable from an external source.

4. The powered toothbrush according to claim 1, wherein the single battery is selected from the group consisting of AA, AAA, 9V and C.

5. The powered toothbrush according to claim 1, wherein the single battery is positioned in an upright configuration within the inner cavity of the handle.

6. The powered toothbrush according to claim 5, wherein the single battery is positioned below the rotary drive member.

7. The powered toothbrush according to claim 1, wherein the handle comprises a polymeric material.

8. The powered toothbrush according to claim 1, wherein the powered toothbrush is water-repellant.

9. The powered toothbrush according to claim 1, wherein the flexible drive shaft is made of a polymeric material.

10. The powered toothbrush according to claim 9, wherein the polymeric material is a thermoplastic elastomer.

11. The powered toothbrush according to claim 1, wherein the curved neck is injection molded.

12. A powered toothbrush comprising:
a handle having an inner cavity formed therein and a base member at one end thereof;
a rotary drive member disposed within the inner cavity;
a curved tubular neck portion having a constant radius extending from the other end of the handle portion with a head coupled to the neck portion, the head including at least one bristle carrier comprising bristles, wherein the at least one bristle carrier is adapted to move in a first rotational direction;
a flexible drive shaft for moving the at least one bristle carrier in a first rotational direction, having a first end and a second end, rotatably disposed within the curved tubular neck portion, the first end thereof being drivably connected to the drive member and the second end thereof extending through the outer end of the curved tubular neck portion, the flexible drive shaft being rotationally responsive to the rotary drive member; and
a single battery to power the rotary drive member.

13. The powered toothbrush according to claim 12, wherein said powered toothbrush comprises at least two bristle carriers.

14. The powered toothbrush according to claim 12, wherein the single battery is removable or fixed, rechargeable, non-rechargeable or rechargeable from an external source.

15. The powered toothbrush according to claim 12, wherein the single battery is selected from the group consisting of AA, AAA, 9V and C.

16. The powered toothbrush according to claim 12, wherein the single battery is positioned in an upright configuration within the inner cavity of the handle.

17. The powered toothbrush according to claim 16, wherein the single battery is positioned below the rotary drive member.

18. The powered toothbrush according to claim 12, wherein the handle comprises a polymeric material.

19. The powered toothbrush according to claim 12, wherein the powered toothbrush is water-repellant.

20. The powered toothbrush according to claim 12, wherein the flexible drive shaft is made of a polymeric material.

21. The powered toothbrush according to claim 20, wherein the polymeric material is a thermoplastic elastomer.

22. The powered toothbrush according to claim 12, wherein the curved neck is injection molded.

23. A powered toothbrush comprising:
a handle having an inner cavity formed therein and a base member at one end thereof;
a rotary drive member disposed within the inner cavity, the drive member comprising a clutch mechanism;
a curved tubular neck portion extending from the other end of the handle portion with a head coupled to the neck portion, the head including at least one bristle carrier comprising bristles, wherein the at least one of the bristle carrier is adapted to move in a first rotational direction; and
a flexible drive shaft for moving the at least one bristle carrier in a first rotational direction, having a first end and a second end, rotatably disposed within the curved tubular neck portion, the first end thereof being drivably connected to the drive member and the second end thereof extending through the outer end of the curved tubular neck portion, the flexible drive shaft being rotationally responsive to the rotary drive member;
a single battery to power the rotary drive member; and
wherein the clutch mechanism disengages the flexible drive shaft upon an overpressure to prevent damage to the bristles.

24. The powered toothbrush according to claim 23, wherein said powered toothbrush comprises at least two bristle carriers.

25. The powered toothbrush according to claim 23, wherein the single battery is removable or fixed, rechargeable, non-rechargeable or rechargeable from an external source.

26. The powered toothbrush according to claim 23, wherein the single battery is selected from the group consisting of AA, AAA, 9V and C.

27. The powered toothbrush according to claim 23, wherein the single battery is positioned in an upright configuration within the inner cavity of the handle

28. The powered toothbrush according to claim 27, wherein the single battery is positioned below the rotary drive member.

29. The powered toothbrush according to claim 23, wherein the handle comprises a polymeric material.

30. The powered toothbrush according to claim 23, wherein the powered toothbrush is water-repellant.

31. The powered toothbrush according to claim 23, wherein the flexible drive shaft is made of a polymeric material.

32. The powered toothbrush according to claim 23, wherein the polymeric material is a thermoplastic elastomer.

33. The powered toothbrush according to claim 23, wherein the curved neck is injection molded.

34. A powered toothbrush with a single battery which drives a unitary flexible direct drive shaft with a curved section through a curved neck section to, in turn, drive at least two bristle carriers with bristles which extend generally to intersect the longitudinal axis of a handle section of the toothbrush.

35. The powered toothbrush according to claim 34, wherein the single battery is removable or fixed, rechargeable, non-rechargeable or rechargeable from an external source.

36. The powered toothbrush according to claim 34, wherein the single battery is selected from the group consisting of AA, AAA, 9V and C.
